(19) United States
(12) Patent Application Publication
(10) Pub. No.: US 2009/0280289 A1
(43) Pub. Date: Nov. 12, 2009

(54) THREE-DIMENSIONAL ROOM BORDER

(76) Inventors: Jorge Padron, Naples, FL (US); Gisel Padron, Naples, FL (US)

Correspondence Address: EDWARD M. LIVINGSTON, PA, 963 TRAIL TERRACE DRIVE, NAPLES, FL, 34103, US

(21) Appl. No.: 12/119,126

(22) Filed: May 12, 2008

(51) Int. Cl. B32B 3/06

(52) U.S. Cl. 428/100; 428/99

(57) ABSTRACT

A three-dimensional room border (1) having raised elements (2 and 3), each having a front surface (4) and a back surface (13), wherein each front surface (4) has a predetermined height (15) extending outwardly from each back surface (13). A predetermined design (10) is located on the front surface (4) so as to provide a decorative element to the raised elements (2 and 3). At least one tab (6) may be located on the raised elements (2 and 3) to permit a user to secure the raised elements (2 and 3) to other raised elements (2 and 3), a wall (14) or both (3 or 14). The three-dimensional room border (1) may also include a three-dimensional corner piece (18) that is secured to a wall corner (19). In addition, the raised elements (2 and 3) may be located on a section (9) so as to cover a predetermined length of wall (14) when secured thereto.

### BACKGROUND OF THE INVENTION

This invention relates to room borders, more particularly, a decorative room border having a three-dimensional appearance so as to give a more aesthetic, life-like appearance to a room.

Currently, room borders are utilized on the upper- and/or mid-portion of walls of a room so as to permit individuals to customize the appearance of a room to his/her liking. The borders are typically constructed of a wallpaper or other planar, flexible material having a front surface and a back surface. Each border typically includes at least one design located on the front surface and an adhesive material on the back surface so as to permit the border to be adhered to the surface of the wall.

Although these types of room borders do have an aesthetic quality to them, they are limited in that the designs located on the front surface of the borders give a two-dimensional appearance. These types of borders may be appropriate for businesses or rooms catered for adults; however, children, especially young, creative, imaginative children, soon find these types of borders blase.

Moreover, these types of room borders are designed so as to lay flat against the surface of the wall so as to promote a one-dimensional appearance. In fact, great pains are taken to ensure that the room borders are free of any air pockets so as to give this one-dimensional, sleek, planar, professional appearance. Thus, once again, these types of room borders soon become boring to children.

Moreover, although crown molding and chair molding do provide a three-dimensional appearance to a wall when secured thereto, the moldings are typically manufactured so as to have a uniform, linear look thereto, without the inclusion of any decorative character or object elements that would inspire creativity and imagination in a child.

Furthermore, the aforementioned borders and moldings are secured to the wall in a permanent manner. Thus, if a person no longer wishes to have the border or molding, either because he/she is tired of the design, wants to utilize a new border or molding or needs to remove the border or molding because he/she is moving, the process of removing the border and/or molding is tedious and difficult. In addition, oftentimes there is extensive damage to the wall due to the removal of the border and/or molding.

Thus, a need exists for a decorative room border having a three-dimensional appearance so as to give a more aesthetic, life-like appearance to a room and is easy to install and remove while causing minimal damage to a wall.

The relevant prior art includes the following references:

| Patent No. | | |
|---|---|---|
| (U.S. unless stated otherwise) | Inventor | Issue/Publication Date |
| 6,627,284 | Naidj | Sep. 30, 2003 |
| 6,132,821 | Garr | Oct. 17, 2000 |
| 4,900,604 | Martinez et al. | Feb. 13, 1990 |
| 5,196,246 | Kauss et al. | Mar. 23, 1993 |
| 5,491,006 | Johnson et al. | Feb. 13, 1996 |
| 5,620,764 | Schwarz et al. | Apr. 15, 1997 |
| 3,822,494 | Zivica | Jul. 09, 1974 |
| 5,523,129 | McGeehan-Hatch | Jun. 04, 1996 |
| 4,143,496 | Destito | Mar. 13, 1979 |
| 6,228,194 | Cowen | May 08, 2001 |

### SUMMARY OF THE INVENTION

The primary object of the present invention is to provide a three-dimensional room border that gives a more aesthetic, life-like appearance to a room.

A further object of the present invention is to provide a three-dimensional room border that is easy to install on a wall.

Another object of the present invention is to provide a three-dimensional room border that is easy to remove from a wall.

An even further object of the present invention is to provide a three-dimensional room border that permits a user to customize the border with various raised elements.

Another object of the present invention is to provide a three-dimensional room border that causes minimal damage to a wall when removed.

The present invention fulfills the above and other objects by providing a three-dimensional room border having first and second raised elements, each having a front surface and a back surface, wherein each front surface has a predetermined height extending outwardly from each back surface. A predetermined design is located on the front surface so as to provide a decorative element to the raised elements. At least one fastening means is located on the first raised element to permit a user to secure the first raised element to the second raised element, a wall or both.

The three-dimensional room border may also include a three-dimensional corner piece that is secured to a wall corner and to adjoining raised elements.

In addition, the raised elements may be located on a section so as to cover a predetermined length of wall when secured thereto.

To use the present invention, a person positions each raised element or, in the alternative, each section, on a predetermined location on a wall, preferably near the ceiling. The user then secures the raised elements and/or sections to the wall as desired. Because the room border is easy to install and remove, a user may interchange the border as often as desired with little to no damage to the wall.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a three-dimensional room border of the present invention;

FIG. 2 is a front plan view of a three-dimensional room border of the present invention;

FIG. 3 is a top plan view of the embodiment of FIG. 2;

FIG. 4 is a front plan view of a three-dimensional room border of the present invention;

FIG. 5 is a front perspective view of a three-dimensional room border of the present invention installed in a room;

FIG. 6 is a top view of a corner piece of the three-dimensional room border of the present invention;

FIG. 7 is a front plan view of a raised element of the three-dimensional room border of the present invention;

FIG. 8 is a rear view of the embodiment of FIG. 7;

FIG. 9 is front plan view of the three-dimensional room border of the present invention;

FIG. 10 is a rear view of the embodiment of FIG. 9;

FIG. 11 is a top view of a three-dimensional room border of the present invention installed on a wall via a hook and loop type material; and

FIG. 12 is a top view of a three-dimensional room border of the present invention installed on a wall via an adhesive material.

### DESCRIPTION OF THE PREFERRED EMBODIMENTS

For purposes of describing the preferred embodiment, the terminology used in reference to the numbered components in the drawings is as follows:

| | |
|---|---|
| 1. | three-dimensional room |
| | border, generally |
| 2. | first raised element |
| 3. | second raised element |
| 4. | front surface |
| 5. | fastening means |
| 6. | tab |
| 7. | aperture |
| 8. | perimeter |
| 9. | section |
| 10. | design |
| 11. | screw |
| 12. | housing |
| 13. | back surface |
| 14. | wall |
| 15. | height |
| 16. | snap |
| 17. | snap receiving means |
| 18. | corner piece |
| 19. | corner |
| 20. | hook and loop type material |
| 21. | intermediate raised element |
| 22. | adhesive material |

With reference to FIG. 1, a front view of a three-dimensional room border of the present invention is shown. The three-dimensional room border, generally 1, includes a first raised element 2 and a second raised element 3, each having a front surface 4 outwardly extending from a back surface 13 (as shown in FIGS. 3, 6, 11 and 12) wherein a predetermined design 10 is located on the front surface 4. Located between and connected to the first raised element 2 and second raised element 3 is at least one intermediate raised element 21 having a front surface 4 wherein a predetermined design 10 is located on the front surface 4, which in turn forms a section 9. Each raised element 2, 3 and 21 has a perimeter 8 of a predetermined shape. The section 9 is secured to a substantially planar surface via fastening means 5, which may be at least one tab 6 having at least one aperture 7 located thereon. In addition to attaching a section 9 to a substantially planar surface or in the alternative thereto, each section 9 may be secured to another section 9 so as to extend a predetermined length across the substantially planar surface.

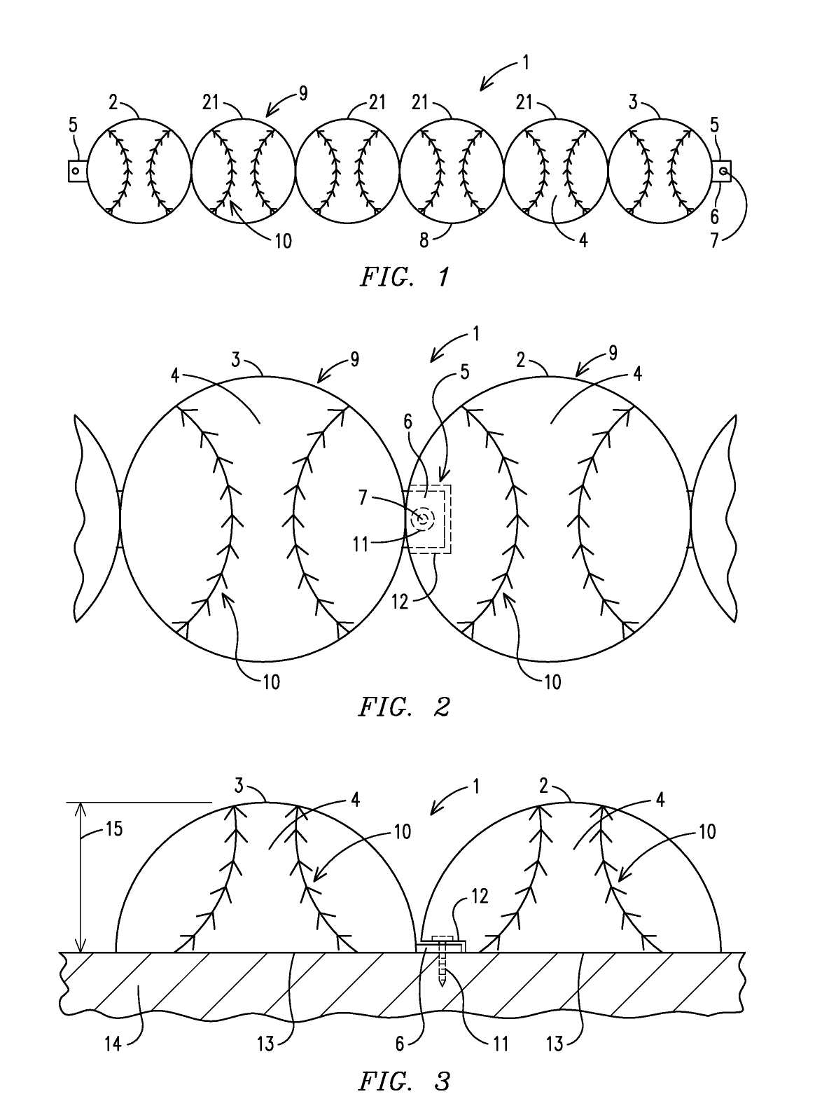

Next, FIG. 2 shows a front plan view of a three-dimensional room border of the present invention. The three-dimensional room border 1 includes at least one fastening means 5 for securing the first raised element 2 of one section 9 to the second raised element 3 on a another section 9. The fastening means 5 may be a tab 6 extending from the second raised element 3 and securable to the first raised element 2. The tab 6 preferably includes at least one aperture 7 for insertion of a screw 11, bolt or any other similar object to permit a user to secure the raised element(s) 2 and 3 to a substantially planar surface. The tab 6 preferably extends into a housing 12 located on the first raised element 2 so as to secure the second raised element 2 to the first raised element 2.

FIG. 3 shows a top plan view of the embodiment of FIG. 2. Each raised element 2, 3 and 21 (not shown) includes a front surface 4 and a back surface 13. Each front surface 4 has a predetermined height 15 extending outwardly from each back surface 13 so as to create a three-dimensional effect. When in use, the three-dimensional room border 1 of the present invention is secured to a substantially flat surface, such as a wall 14, wherein the design(s) 10 on the front surface 4 are visible. The screw 11 extends through the aperture 7 in the tab 6 and through an aperture 7 in the housing 12 so as to secure the raised elements 2 and 3 to the wall 14.

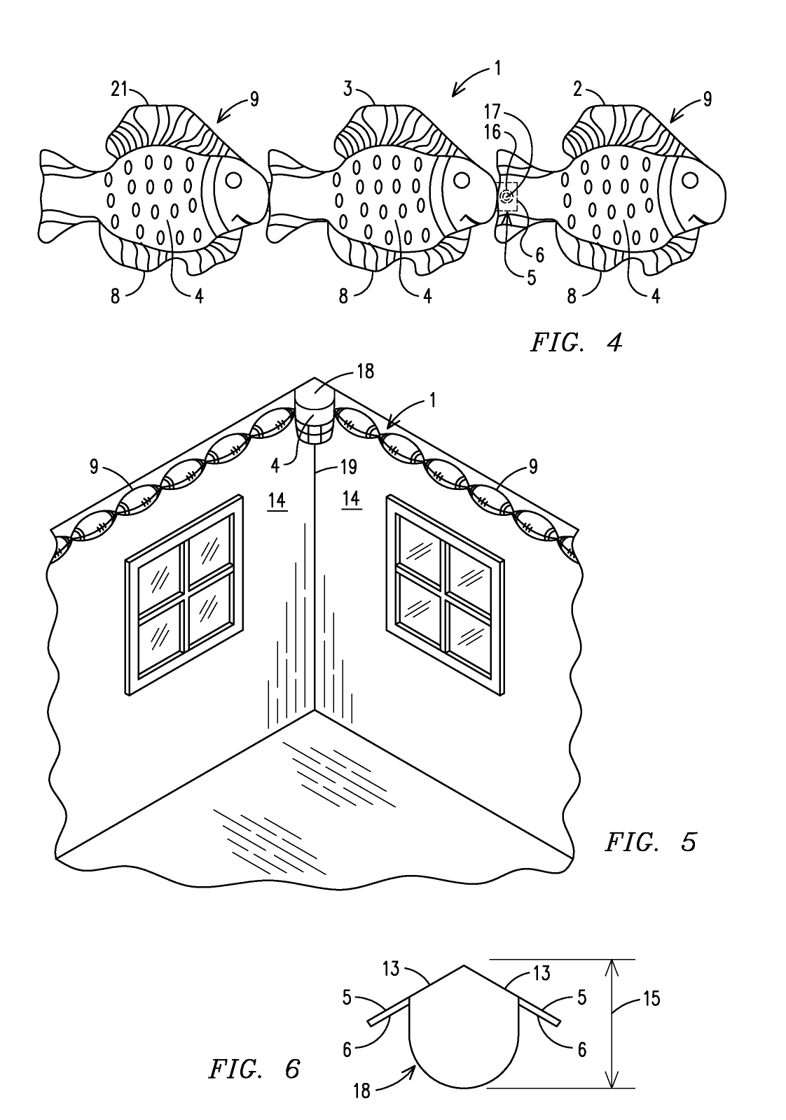

Next, FIG. 4 shows a front plan view of a three-dimensional room border of the present invention. The three-dimensional room border 1 may be formed of a plurality of sections 9, each having a first raised element 2, a second raised element 3 and at least one intermediate raised element 21 located therebetween, secured to one another via at least one fastening means 5. As shown in FIG. 4, the fastening means 5 may be at least one snap 16 located on a tab 6 on the second raised element 3 and a corresponding snap receiving means 17 located on the first raised element 2 to permit a user to snap-fit one section 9 to another section 9.

Next, FIG. 5 shows a front perspective view of a three-dimensional room border of the present invention installed in a room. The three-dimensional room border 1 preferably includes a plurality of sections 9 joined together and secured to an uppermost portion of the wall 14 and at least one corner piece 18 secured in a corner 19. The corner piece 18, which is a raised element 3, preferably includes all of the structural components of the raised elements 2 and 3 described above. That is, the corner piece 18 preferably includes a front surface 4 having a predetermined design 10, a back surface 13 and at least one fastening means 5 (as shown in FIG. 6) wherein the front surface 4 has a predetermined height 15 formed by the front surface 4 outwardly extending a predetermined height 15 from the back surface 13. Thus, the three-dimensional room border 1 may be used to span the entire length of the wall 14, inclusive of corner(s) 19.

FIG. 6 is a top view of a corner piece of the three-dimensional room border of the present invention. The corner piece 18 includes a back surface 13 formed for insertion and securement into a corner 19 of a room. The corner piece 18 includes at least one fastening means 5, preferably at least one tab 6 having at least one aperture 7, to permit a user to secure the corner piece 18 to the wall 14 and to the raised elements 2 and 3/sections 9. The corner piece 18 also has a front surface 4 having a predetermined height 15 extending outwardly from the back surface 13 so as to create a three-dimensional effect.

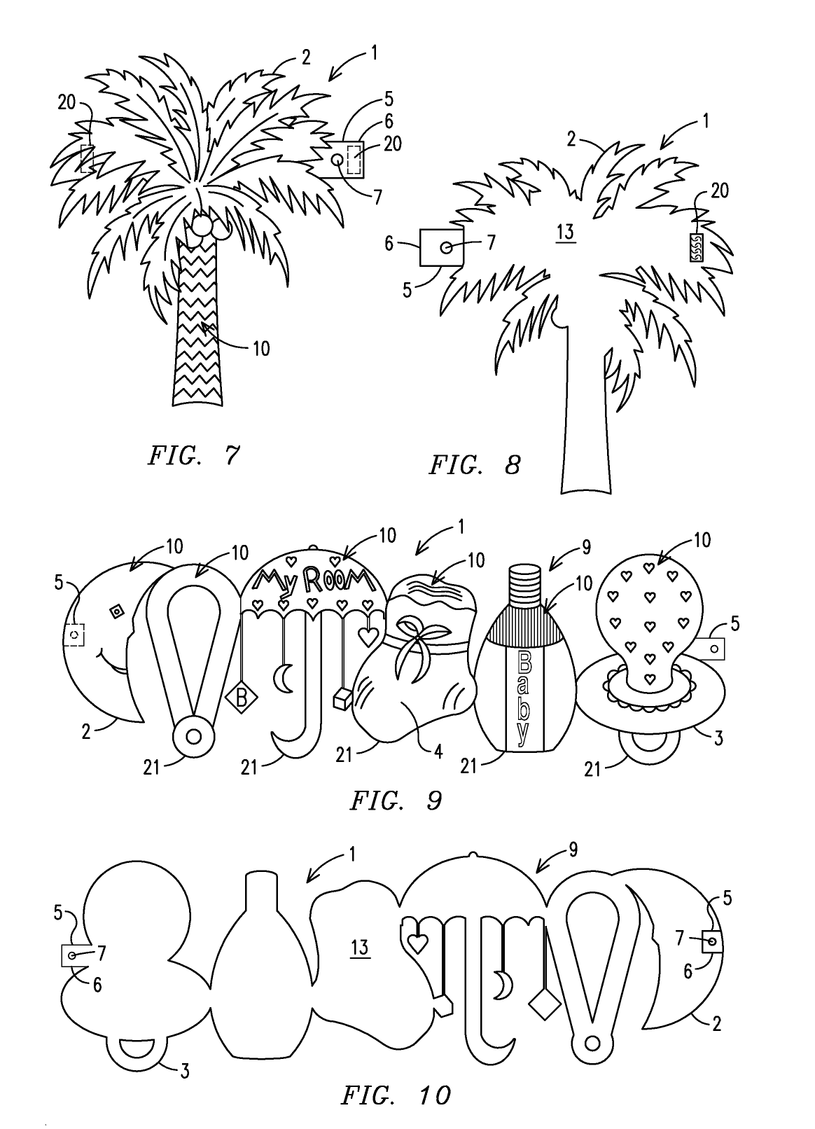

With reference to FIGS. 7 and 8, varying views of a raised element of the three-dimensional room border of the present invention are shown. The three-dimensional room border 1 may be formed of at least one second raised element 3 having at least one fastening means 5 located thereon permanently or removably securable to at least one first raised element 2. Thus, rather than having a plurality of sections 9 secured to one another, the three-dimensional room border 1 of the present invention may be formed of a plurality of first and second raised elements 2 and 3 secured to one another via at least one fastening means 5.

The fastening means 5 may be at least one hook and loop type material 20 located on both raised elements 2 and 3, preferably on the back surfaces 13, and a corresponding hook and loop type material, preferably on the tabs 6. In this manner, a user may quickly and easily secure the hook and loop type material 20 on the tab 6 of the second raised element 3 to hook and loop type material 20 located on the back surface 13 of the first raised element 2 to create a three-dimensional room border 1 of his/her desired length.

Next, FIGS. 9 and 10 are varying views of the three-dimensional room border of the present invention. The three-dimensional room border 1 may include at least one section 9 having at least one fastening means 5 located thereon. The fastening means 5 may extend from the first or second raised element 2 or 3 or, in the alternative, the fastening means 5 may be located behind the first or second raised element 2 or 3 so as to be hidden from view when looking at the front of the three-dimensional room border 1.

Each section 9 includes a first raised element 2, a second raised element 3 and at least one intermediate raised element 21 located between the first raised element 2 and second raised element 3. Each raised element 2, 3 and 21 may have the same design 10 and perimeter 8 or, in the alternative, each raised element 2, 3 and 21 may each have differing designs 10 and perimeters 8. Additionally, each raised element 2, 3, and 21 has a front surface 4 that outwardly extends from the back surface 13 a predetermined height 15 so as to create a three-dimensional effect.

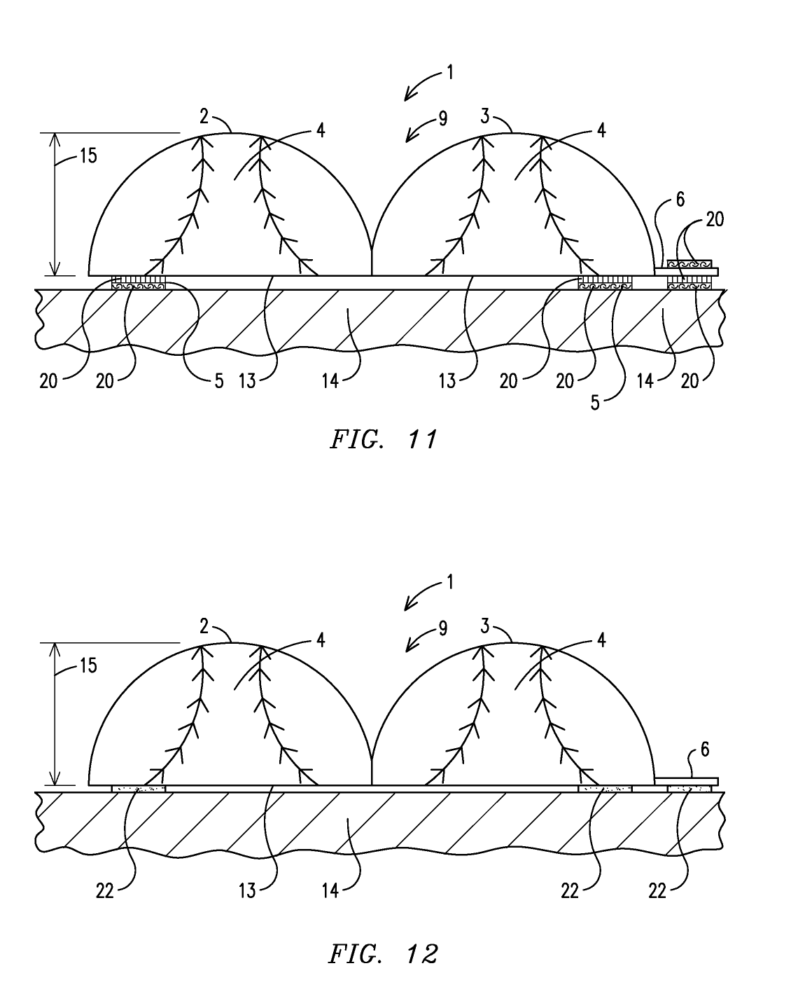

With respect to FIG. 11, a top view of a three-dimensional room border of the present invention installed on a wall via a hook and loop type material is shown. The fastening means 5 on the three-dimensional room border 1 may take the form of hook and loop type material 20 located on the back surface 13 of the raised elements 2, 3 and 21 or section 9 and have a corresponding hook and loop type fastening means 5 located on the wall 14 to permit a user to quickly and easily secure the three-dimensional room border 1 of the present invention to the wall 14. In addition or in the alternative, the hook and loop type material 20 may be located on the tab 6 and/or on the back surface of the raised elements 2, 3 and 21 or section 9 so permit a user to secure one raised element 2, 3 or 21 to another or one section 9 to another.

Finally, FIG. 12 shows a top view of a three-dimensional room border of the present invention installed on a wall via an adhesive material. The fastening means 5 on the three-dimensional room border 1 may take the form of adhesive material 22 located on the back surface 13 of the raised elements 2, 3 and 21 or section 9 to permit a user to quickly and easily secure the three-dimensional room border 1 of the present invention to the wall 14. In addition or in the alternative, the adhesive material 22 may be located on the tab 6 and/or on the back surface of the raised elements 2, 3 and 21 or section 9 so permit a user to secure one raised element 2, 3 or 21 to another or one section 9 to another.

The three-dimensional room border 1 of the present invention may be sold as a kit having a plurality of first and second raised sections 2 and 3, a plurality of corner pieces 18 and a plurality of pre-formed sections 9.

The use of the present invention will give a more aesthetic, life-like appearance to a room.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A three-dimensional room border comprising:
at least two raised elements, a first raised element and a second raised element;
said first raised element having a front surface and a back surface;
said first raised element having a perimeter of a predetermined shape;
said first raised element front surface having a predetermined design;
said first raised element front surface having a first predetermined height extending outwardly from said first raised element back surface;
said second raised element having a front surface and a back surface;
said second raised element having a perimeter of a predetermined shape;
said second raised element front surface having a predetermined design;
said second raised element front surface having a predetermined height extending outwardly from said back surface;
at least one fastening means located on said second raised element for securing said second raised element to said first raised element; and
at least one fastening means located on said first raised element for securing said first raised element to a substantially planar surface.

2. The three-dimensional room border of claim 1 wherein:
said at least one fastening means located on said second raised element for securing
said second raised element to said first raised element is at least one tab.

3. The three-dimensional room border of claim 2 wherein:
said at least one tab has at least one aperture.

4. The three-dimensional room border of claim 3 further comprising:
at least one screw for insertion into said at least one aperture for securing said second raised element to a wall.

5. The three-dimensional room border of claim 2 further comprising:
at least one snap located on said at least one tab for securing said second raised element to said first raised element.

6. The three-dimensional room border of claim 4 further comprising:
at least one snap located on said at least one tab for securing said second raised element to said first raised element; and
at least one snap receiving means located on said second raised element.

7. The three-dimensional room border of claim 1 wherein:
said second raised element is a corner piece.

8. The three-dimensional room border of claim 1 wherein:
said at least one fastening means located on said second raised element for securing said second raised element to said first raised element is at one least hook and loop type material; and
at least one corresponding hook and loop type material is located on said first raised element for securing said second raised element to said first raised element.

9. The three-dimensional room border of claim 2 further comprising:
at least one hook and loop type material located on said at least one tab; and
at least one corresponding hook and loop type material located on said first raised element for securing said second raised element to said first raised element.

10. The three-dimensional room border of claim 1 wherein:
said at least one fastening means located on said second raised element for securing said second raised element to said first raised element is at one adhesive material.

11. The three-dimensional room border of claim 1 wherein:
said at least one fastening means located on said first raised element for securing said first raised element to a substantially planar surface is at one least hook and loop type material; and
at least one corresponding hook and loop type material is located on said substantially planar surface for securing said first raised element to said substantially planar surface.

12. A three-dimensional room border comprising:
a raised element having a front surface and a back surface;
said raised element having a perimeter of a predetermined shape;
said raised element front surface having a predetermined design;
said raised element front surface having a predetermined height extending outwardly from said raised element back surface; and
at least one fastening means located on said raised element for securing said raised element to a substantially planar surface.

13. The three-dimensional room border of claim 12 wherein:
said substantially planar surface is a wall.

14. The three-dimensional room border of claim 12 wherein:
said at least one fastening means is at least one tab.

15. The three-dimensional room border of claim 14 wherein:
said at least one tab has at least one aperture.

16. The three-dimensional room border of claim 15 further comprising:
at least one screw for insertion into said at least one aperture for securing said raised element to a wall.

17. The three-dimensional room border of claim 12 wherein:
said at least one fastening means is at least adhesive material.

18. The three-dimensional room border of claim 12 wherein:
said at least one fastening means is at least one hook and loop type material; and
at least one corresponding hook and loopy type material located on said substantially planar surface.

19. The three-dimensional room border of claim 14 further comprising:
a second raised element having a front surface and a back surface;
said second raised element having a perimeter of a predetermined shape;
said second raised element front surface having a predetermined design;
said second raised element front surface having a predetermined height extending outwardly from said back surface; and
at least one snap located on said at least one tab to permit a user to secure to said first raised element to said second raised element.

20. The three-dimensional room border of claim 16 further comprising:
a second raised element having a front surface and a back surface;
said second raised element having a perimeter of a predetermined shape;
said second raised element front surface having a predetermined design;
said second raised element front surface having a predetermined height extending outwardly from said back surface; and
at least one snap located on said at least one tab to permit a user to secure to said first raised element to said second raised element.

21. The three-dimensional room border of claim 12 further comprising:
a second raised element having a front surface and a back surface;
said second raised element having a perimeter of a predetermined shape;
said second raised element front surface having a predetermined design;
said second raised element front surface having a predetermined height extending outwardly from said back surface; and
a means for securing said second raised element to said first raised element.

22. The three-dimensional room border of claim 21 wherein:
said second raised element is a corner piece.

23. The three-dimensional room border of claim 21 wherein:
said at least one fastening means located on said first raised element is at least one hook and loop type material; and
at least one corresponding hook and loop type material located on said substantially planar surface to permit a user to secure said first raised element to said substantially planar surface.

24. The three-dimensional room border of claim 21 wherein:
said at least one fastening means located on said first raised element is at least one adhesive material.

25. A three-dimensional room border comprising:
a first section having a first raised element, a second raised element and at least one intermediate raised element located between said first raised element and said second raised element;
said first raised element having a front surface and a back surface;
said second raised element having a front surface and a back surface;
said at least one intermediate raised element having a front surface and a back surface;
said first raised element having a perimeter of a predetermined shape;
said second raised element having a perimeter of a predetermined shape;
said at least one intermediate raised element having a perimeter of a predetermined shape;
said first raised element on said first section front surface having a predetermined design;
said second raised element on said first section front surface having a predetermined design;
said at least one intermediate raised element on said first section front surface having a predetermined design;
said first raised element on said first section front surface having a predetermined height extending outwardly from said first raised element back surface;
said second raised element on said first section front surface having a predetermined height extending outwardly from said second raised element back surface;
said at least one intermediate raised element on said first section front surface having a predetermined height extending outwardly from said at least one intermediate raised element back surface;
a second section having a first raised element, a second raised element and at least one intermediate raised element located between said first raised element and said second raised element;
said first raised element on said second section having a front surface and a back surface;
said second raised element on said second section having a front surface and a back surface;
said at least one intermediate raised element on said second section having a front surface and a back surface;
said first raised element on said second section having a perimeter of a predetermined shape;
said second raised element on said second section having a perimeter of a predetermined shape;
said at least one intermediate raised element on said second section having a perimeter of a predetermined shape;
said first raised element on said second section front surface having a predetermined design;
said second raised element on said second section front surface having a predetermined design;
said at least one intermediate raised element on said second section front surface having a predetermined design;
said first raised element on said second section front surface having a predetermined height extending outwardly from said first raised element back surface;
said second raised element on said second section front surface having a predetermined height extending outwardly from said second raised element back surface;
said at least one intermediate raised element on said first section front surface having a predetermined height extending outwardly from said at least one intermediate raised element back surface;
at least one fastening means located on said first section for securing said first section to said second section; and
at least one fastening means located on said first raised element for securing said first raised element to a substantially planar surface.

26. The three-dimensional room border of claim 25 wherein:
said at least one fastening means is at least one tab.

27. The three-dimensional room border of claim 26 wherein:
said at least one tab has at least one aperture.

28. The three-dimensional room border of claim 27 further comprising:
at least one screw for insertion into said at least one aperture for securing said first section to a wall.

29. The three-dimensional room border of claim 26 further comprising:
at least one snap located on said at least one tab for securing said second raised element to said first raised element; and
at least one snap receiving means located on said second raised element.

30. The three-dimensional room border of claim 25 wherein:
said second section is a corner piece.

31. The three-dimensional room border of claim 25 wherein:
said at least one fastening means located on said first section is at least one hook and loop type material; and
at least one corresponding hook and loop type material is located on said second section for securing said second section to said first section.

32. The three-dimensional room border of claim 26 further comprising:
at least one hook and loop type material located on said at least one tab; and
at least one corresponding hook and loop type material located on said second section for securing said second section to said first section.

33. The three-dimensional room border of claim 25 wherein:
said at least one fastening means located on said second section is at least one adhesive material.

34. A three-dimensional room border comprising:
a first section having a first raised element, a second raised element and at least one intermediate raised element located between said first raised element and said second raised element;
said first raised element having a front surface and a back surface;
said second raised element having a front surface and a back surface;
said at least one intermediate raised element having a front surface and a back surface;
said first raised element having a perimeter of a predetermined shape;
said second raised element having a perimeter of a predetermined shape;
said at least one intermediate raised element having a perimeter of a predetermined shape;
said first raised element on said first section front surface having a predetermined design;
said second raised element on said first section front surface having a predetermined design;
said at least one intermediate raised element on said first section front surface having a predetermined design;
said first raised element on said first section front surface having a predetermined height extending outwardly from said first raised element back surface;
said second raised element on said first section front surface having a predetermined height extending outwardly from said second raised element back surface;
said at least one intermediate raised element on said first section front surface having a predetermined height extending outwardly from said at least one intermediate raised element back surface; and
at least one fastening means located on said first section for securing said first section to a substantially planar surface.

35. The three-dimensional room border of claim 34 wherein:
said at least one fastening means is at least one tab.

36. The three-dimensional room border of claim 35 wherein:
said at least one tab has at least one aperture.

37. The three-dimensional room border of claim 36 further comprising:
at least one screw for insertion into said at least one aperture for securing said first section to a wall.

38. The three-dimensional room border of claim 35 further comprising:
at least one snap located on said at least one tab to permit a user to secure said second section to said first section.

39. The three-dimensional room border of claim 38 further comprising:
at least one snap located on said at least one tab for securing said second section to said first section.

40. The three-dimensional room border of claim 34 wherein:
said second section is a corner piece.

41. The three-dimensional room border of claim 34 wherein:
said at least one fastening means on said first section is at least one hook and loop type material; and
at least one corresponding hook and loop type material is located on said second section to permit a user to secure said second section to said first section.

42. The three-dimensional room border of claim 35 further comprising:
at least one hook and loop type material located on said at least one tab; and
at least one corresponding hook and loop type material located on said second section to permit a user to secure said second section to said first section.

43. The three-dimensional room border of claim 34 wherein:
said at least one fastening means on said first section is at least one least one adhesive.
